(19) United States
(12) Patent Application Publication
(10) Pub. No.: US 2002/0063671 A1
(43) Pub. Date: May 30, 2002

(54) Active matrix liquid crystal display devices

(75) Inventor: Alan G. Knapp, Crawley (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/008,217

(22) Filed: Nov. 8, 2001

(30) Foreign Application Priority Data
Nov. 28, 2000 (GB) 0028875.3

(51) Int. Cl. G09G 3/36

(52) U.S. Cl. 345/87

(57) ABSTRACT

In an active matrix LC display device comprising a matrix array of display pixels (10) that are addressed via sets of row and column address conductors (14, 16) by row and column drivers (30, 35) operable to select each row of pixels in sequence and apply data signals to the selected row, the column address conductors are divided, preferably around the centre of the array, to define first and second display sub-matrices (50, 51) to which data signals are supplied by first and second column drivers (35A, 35B) respectively that operate substantially alternately. Through division of the column address conductors, each sub-matrix presents a lower capacitive load and consequently less power is consumed in driving the pixel columns.

The present invention relates to an active matrix liquid crystal display device comprising a row and column array of pixels defining a display area, each pixel comprising a liquid crystal display element connected to a switching device, sets of row and column address conductors connected to the pixels and via which selection signals and data signals respectively are applied to the pixels, a row driver for applying selection signals to the row address conductors so as to select each row of pixels of the array in turn, and a column driver for applying data signals to a selected row of pixels via the column address conductors.

Active matrix liquid crystal display devices of the above kind, and suitable for displaying datagraphic or video information, are well known. Typical examples of such, and the general manner in which they operate, are described in U.S. Pat. No. 5,130,829. In these, electrodes of the display elements, organised in rows and columns, are provided on a first substrate together with the switching devices, in the form of TFTs (thin film transistors), and the sets of row and column address conductors. An overlying second substrate carries a transparent common electrode and each display element is defined by a respective display element electrode, an overlying portion of the common electrode and LC material disposed therebetween. Each display element electrode is connected to the drain electrode of its associated TFT. The TFT of each pixel is connected to respective ones of the row and column address conductors with the gates of all the TFTs in a row of pixels being connected to a respective row address conductor and the source electrodes of all the TFTs in a column of pixels being connected to a respective column address conductor. A row driver circuit connected to the set of row address conductors scans the row conductors by applying a selection (gating) signal to each row conductor in sequence to turn on the TFTs of a row of pixels and a column driver circuit connected to the set of column conductors applies data signals to the column conductors in synchronism with scanning of the row conductors by the row drive circuit whereby the display elements of a selected row are charged via their respective TFTs to a level dependent on the value of the data signal on their associated column conductors so as to produce a required display output. The rows are driven individually in turn during respective row address periods in this manner so as to build up a display picture over one field (frame) period in which all the rows are addressed once, and the array of pixels is repeatedly addressed in similar manner in successive field periods.

When using display devices of this kind in portable, battery-powered, applications such as computers, PDAs, mobile phones and the like, power consumption is an important issue. Display devices operating in a reflective mode, and thereby avoiding the need to use a backlight, offer benefits in this respect but there is still a need to reduce power consumption levels further, particularly with regard to the column driver circuit which can consume a significant amount of power when driving the pixel array due to the fact that the column conductors each have an inherent associated capacitive value which can be substantial. This capacitance can result, for example, from the capacitance between a display element electrode and two column conductors extending adjacent thereto together with the display element capacitance itself, which may further include a display element storage capacitor, a parasitic capacitance of the switching device, and a capacitance associated with the column conductor which includes capacitance between the column conductor and each row conductor at the cross-overs, and the capacitance between the column conductor and the common electrode.

According to the present invention, there is provided an active matrix liquid crystal display device as described in the opening paragraph wherein the column address conductors are each divided into first and second portions to define respectively first and second display regions of the display area and the portions of the column address conductors in each of the two display regions are connected respectively to first and second column drivers which are arranged to operate at least substantially alternately to supply data signals for pixels in the first and second display regions respectively as the relevant rows are selected by the row driver.

By dividing the column address conductors in this manner and effectively forming two display sub-matrices whose respective pixels are addressed with data signals supplied by first and second column drivers operating in alternate fashion, significant reduction in the power consumed by the column driver circuitry is achieved. While one sub-matrix is being addressed and the associated column driver is operating to apply data signals thereto, the other column driver is inactive, that is idle or inoperative, and for example may be turned off or placed in a low power mode in which it does not generate output data signals. During addressing of the whole array in one field period in which all the rows of pixels in the array are selected in turn, the column drivers are operable in succession and each only for a part of the field period. Because each column driver is thus required to drive only a portion of the pixel columns, and hence only a corresponding proportion of the total capacitance associated with the columns, significantly less power is consumed in the output stages of the column drivers compared to the case where a single column driver is used to drive the whole column capacitance. Moreover, because the output devices in the column drivers coupled to respective column address conductors are required to drive less capacitance, they can be made physically smaller, thereby in turn presenting a smaller capacitive load to other parts of the column driver circuitry and hence reducing the power consumption in those other parts.

If the first at second column drivers are integrated on the active matrix substrate and fabricated simultaneously with the active matrix circuitry by the same thin film technology, for example using polysilicon TFTs, then the provision of two column drivers does not add unduly to either the cost or complexity of manufacture.

Active matrix liquid crystal display devices in which the matrix array of pixels is effectively divided into two (upper and lower) sub-matrices by splitting the column address conductors and in which the column address conductors in each sub-matrix are supplied with data signals by two separate column driver circuits are known. However, the purpose is to allow more time for addressing pixel rows and reduce flicker effects and in these known devices the sub-matrices are addressed simultaneously rather than consecutively, for example with corresponding rows of pixels in each sub-matrix being selected and provided with data signals at the same time, i.e with the first rows in each sub-matrix being addressed together, followed by the second rows, and so on. As a consequence of this manner of driving, the frequency of addressing the pixel can be halved which could result in some reduction of power dissipated in the column driver circuits. However, in order to achieve this simultaneous addressing of the sub-matrices external circuits are required to generate a video signal with an appropriately altered format which circuits themselves consume power and so negate any benefit in any power savings in the column driver circuits that may be obtained.

Preferably, the column address conductors are divided around the middle of the array, i.e approximately mid-way along their length, so that the first and second regions of the display area each comprise approximately one half of the pixel array. Rather than the point of division in the column address conductors occurring at the same point in each case, with the divisions in the conductors all then lying between the same two adjacent pixel rows, (e.g. between rows K and K+1), the divisions preferably lie within a small range of adjacent pixel rows centred around the middle of the pixel array, and the division points from column to column may be arranged irregularly, that is varied from column to column, within the small range of adjacent pixel rows. Any slight visible effects in the outputs from pixels adjacent the divisions which might be caused due to the environment of those pixels being different is then much less noticeable. Such spreading of the individual divisions over a plurality of rows of pixels will require the periods for which the two column driver circuits are powered up and operating to be extended and overlap very slightly, by an amount corresponding approximately to the fraction of the field period during which the group of pixel rows in which the divisions occur are to be addressed, rather than being fully consecutive. Any consequential increase in power consumed by the column driver circuits will though be very small.

Embodiments of active matrix liquid crystal display devices (AMLCDs) in accordance with the present invention will now be described, by way of example, with reference to the accompanying drawings, in which:

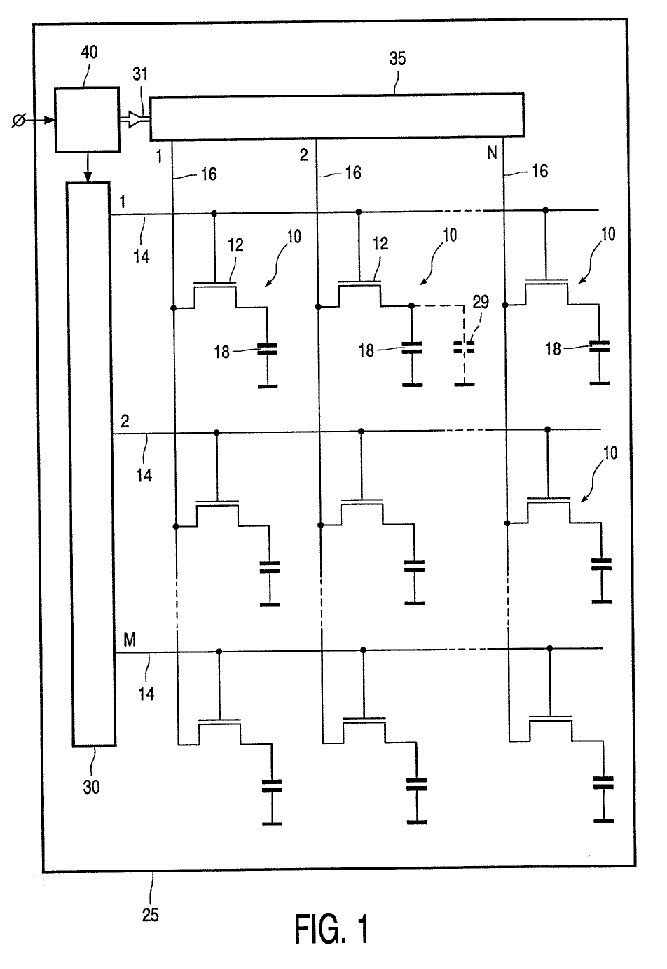

FIG. 1 is a simplified schematic circuit diagram of a known AMLCD;

FIG. 2 is a schematic diagram of a first embodiment of AMLCD according to the present invention; and

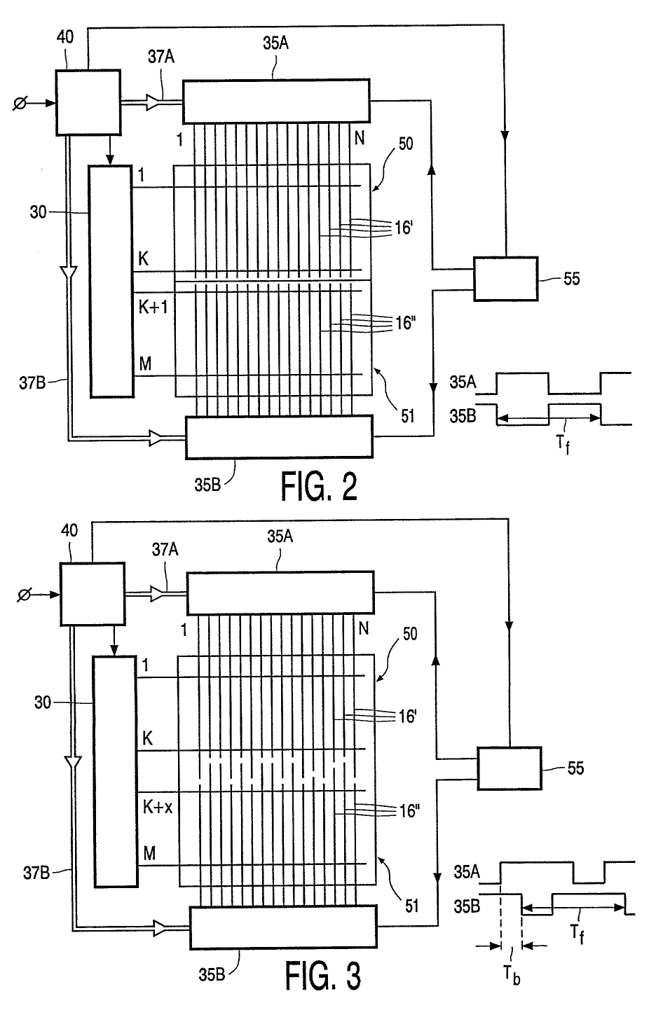

FIG. 3 is a schematic diagram of a second embodiment of AMLCD according to the present invention.

The same reference numerals are used throughout the Figures to denote the same, or similar, parts.

Referring to FIG. 1, a simplified schematic circuit diagram of a generally conventional form of AMLCD, comprising a row and column matrix array (N×M) of display pixels 10, is shown. The display pixels each have a liquid crystal display element 18 and an associated TFT 12 acting as a switching device, and are addressed via sets of (M) row and (N) column address conductors 14 and 16. Only a few display pixels are shown here for simplicity and in practice there can be several hundred rows and columns of pixels. The drain of each TFT 12 is connected to a respective display element electrode situated adjacent the intersection of respective row and column address conductors, while the gates of all the TFTs associated with a respective row of display pixels 10 are connected to the same row address conductor 14 and the sources of all the TFTs associated with a respective column of display pixels are connected to the same column address conductor 16. The conductors 14, 16, the TFTs 12, and the display element electrodes are all carried on the same insulating substrate, for example of glass, and fabricated using known thin film technology involving the deposition and photolithographic patterning of various conductive, insulating and semiconductive layers. A second glass substrate, (not shown) carrying a continuous transparent electrode common to all display elements in the array is arranged spaced from the substrate 25 and the two substrates are sealed together around the periphery of the pixel array to define an enclosed space in which liquid crystal material is contained. Each display element electrode together with an overlying portion of the common electrode and the liquid crystal material therebetween defines a light-modulating LC display element.

The structure and operation of this device follow conventional practice, for example as described in U.S. Pat. No. 5,130,829 whose contents are incorporated herein and to which reference is invited for further details. Briefly, selection (gating) signals are applied to each row address conductor 14 in turn, from row 1 to row M by a row driver circuit 30, comprising for example a digital shift register, and data signals are applied to the column conductors 16, in synchronisation with the selection signals, by a column driver circuit 35. Upon each row conductor 14 being addressed with a selection signal, the pixel TFTs 12 connected to that row conductor are turned on causing the respective display elements to be charged according to the level of the data signal then existing on their associated column conductors. After a row of pixels has been addressed in a respective row address period (T_{L}), corresponding, for example, to the line period of an applied video signal, their associated TFTs are turned off upon termination of the selection signal for the remainder of a field (frame) period in order to isolate electrically the display elements, thereby ensuring the applied charge is stored to maintain their display outputs until they are addressed again in a subsequent field period. Each of the rows of pixels in the array from row 1 to row M is addressed in turn in this way in respective successive row address periods T_{L} so as to build up a display picture from the array in one field period Tf, where Tf is equal to, or slightly greater than M×T_{L}, following which the operation is repeated for successive fields.

The timing of the operation of the row and column driver circuits 30 and 35 is controlled by a timing and control unit 40 in accordance with timing signals derived from an input video signal, obtained for example from a computer or other source. The video information signal in this input signal is supplied by a video signal processing circuit in the unit 40 to the column driver circuit 35 in serial form via a bus 37. This circuit comprises one or more shift register/sample and hold circuits which samples the video information signal in synchronism with row scanning to provide serial to parallel conversion appropriate to the row at a time addressing of the pixel array. Successive fields of video information according to successive fields of the input video signal are written into the array by repetitively addressing the pixel rows of the array in consecutive field periods.

For a transmissive mode of operation, the display element electrodes are formed of a light transparent conductive material such as ITO and the individual display elements serve to modulate light, for example directed onto one side from a backlight, so that a display image, built up by addressing all the pixel rows in the array, can be viewed from the other side. For a reflective mode of operation, the display element electrodes are formed of light reflecting conductive material and light entering the front of the device through the substrate carrying the common electrode is modulated by the LC material at each display element and reflected back through that substrate, depending on their display state, to generate a display image visible to a viewer at the front.

Following known practice, the polarity of the drive voltages applied to the display elements is periodically inverted, for example after every field, to avoid degradation of the LC material. Polarity inversion may also be carried out after every row (row inversion) so as to reduce flicker effects.

FIGS. 2 and 3 illustrate schematically the general configuration of two embodiments of AMLCD in accordance with the present invention. In these figures the circuitry is shown simplified and although individual pixels are not shown it will be appreciated that they are of a form similar to that illustrated in FIG. 1 with each pixel located adjacent the intersection of its respective associated row and column address conductors.

Referring to FIG. 2, the AMLCD differs from that of FIG. 1 principally in that the column address conductors 16 are each divided along their length to form two, electrically separate, portions 16′ and 16″, and two column driver circuits 35A and 35B are provided for addressing the sets of column conductor portions 16′ and 16″ respectively. The division of the column conductors effectively splits the pixel array into two regions 50 and 51 constituting upper and lower sub-matrices respectively. In the example illustrated, the set of conductor portions 16′ terminates at pixel row K and the set of conductor portions 16″ terminates at pixel row K+1. The point along the length of the conductors at which division occurs, between rows K and K+1, is the same and at or near the middle of the pixel array, (e.g. K=M/2). Thus, the sub-matrices are of substantially equal area, corresponding to approximately half of the area of the whole pixel array, and comprise a similar number of pixel rows.

The row driver circuit 30 operates as described previously to apply a selection signal to all the row conductors 14 in sequence from row 1 to row M in one field period (Tf) with each row conductor 14 being supplied with a selection signal in turn in a respective row address period (T_{L}), and this operation is repeated for successive fields.

The column driver circuits 35A and 35B are each designed to drive approximately one half of the pixel array, corresponding to a respective sub-matrix and are supplied with video information from an input video signal from the timing and control unit 40 via respective supply buses 37A and 37B. The outputs of the column driver circuits 35A and 35B are coupled to the ends of the column conductor portions 16′ and 16″ respectively and each supplies data signals to their associated column conductor portions appropriately with scanning of the rows in immediately consecutive time periods, each corresponding to one half of a field period. Thus, the column driver circuits 35A and 35B, providing data signals for the pixels in rows 1 to K and rows K+1 to M respectively, operate alternately with the circuit 35A applying data signals in the first half of the display field period as the rows 1 to K are selected and the column driver circuit 35B applying data signals in the second half of the field period as the rows K+1 to M are selected. The column driver circuit 35B is arranged to be inactive, and either turned off or at least placed in a low power mode in which it does not provide output data signals, in the period when the column driver circuit 35A is turned on and active in supplying data signals for the rows 1 to K and, conversely, the column driver circuit 35A is similarly turned off, or placed in a low power mode, when the column driver circuit 35B is active in supplying data signals for the rows K+1 to M.

The switching of the circuits 35A and 35B between these two modes is determined by a control logic circuit 55 supplied with timing information by the timing and control unit 40. The control timing performed by the circuit 55 in alternately powering the circuits 35A and 35B whereby they operate one after the other is illustrated by the control timing diagram depicted in FIG. 2 in which the high levels denote power on and the low levels denote power off (or low) with Tf indicating one complete field period.

Although one column driver circuit, either circuit 35A or 35B, is still powered and operating at any time over a field period, the manner of operation of the AMLCD results in a significant reduction in power consumed compared to the device of FIG. 1. Power is saved since each of the two column driver circuits 35A and 35B is required to drive only one display sub-matrix, and thus only approximately half the column capacitance. Hence, less power is consumed in their output stages compared to a single column driver circuit that drives the whole column capacitance. Also, as they drive less capacitance, the output devices in each output stage of the column driver circuits, typically TFTs the case of an integrated driver circuit or standard CMOS transistors in the case of a driver circuit provided in IC form, they can be made physically smaller, and in particular with reduced channel width, and, in turn, will present a smaller capacitive load to other parts of the column driver circuitry, thereby reducing power consumption by these parts. Also, some designs of buffer circuit used in such drivers, use a bias current whose level depends on the load capacitance. Therefore, the driving of a lower capacitance reduces this bias current, and hence power consumed.

Particularly when using polysilicon technology for the active matrix circuitry on the substrate 25, the row and column driver circuits can be fully integrated on the same substrate, that is, fabricated at the same time as the active matrix circuitry and from common deposited layers. As such, the additional cost entailed in providing two column driver circuits will be minimal. Moreover, the extra space required to accommodate the two driver circuits rather than just one will be minimal as they can be fabricated to lie mainly beneath the seal line of the LC cell and, bearing in mind that they need comparatively smaller devices in their output stages, the area they occupy physically will be reduced.

With the arrangement of FIG. 2, in which the break between the two parts of all the columns occurs at the same point down the array between two adjacent pixel rows (rows K and K+1) there is a possibility that a slight visible artefact in the nature of a faint line with different brightness or contrast could be produced in operation of the device as the local environment of the pixels adjacent to this division is different from that of other pixels in the array.

FIG. 3 shows schematically the circuit configuration of a second embodiment of AMLCD that alleviates any such problem. The device is similar to that of FIG. 2 except that in this case the breaks in the column address conductors are not aligned such that they all fall between the same pair of adjacent pixel rows. Instead, the divisions in adjacent column address conductors are arranged to occur in a substantially irregular manner between different pixel rows within a range of pixels around the centre of the array.

As shown in FIG. 3, the individual breaks are located between the rows K and K+X, where X>1. In a display array having, say, 600 rows of pixels, this group may consist of, for example, around 10 rows. Preferably the group is centred at the middle of the array, that is, with row K+X/2 corresponding or close to row M/2. The locations of the breaks from column to column are varied, either in a repeating pattern or in a generally random manner (as shown), and mostly fall between different pairs of adjacent rows. Consequently, any slight anomalies in the display outputs from individual pixels at the ends of the column conductors portions 16′ and 16″ caused by the splitting of the column conductors will be much less noticeable as the pixels concerned are now dispersed among other pixels.

Because the sub-matrices defined by splitting the column conductors do not now each comprise a whole number of complete pixel rows, but instead include respective pixels from the same group of rows around the middle of the array, both the column driver circuits 35A and 35B will need to be operating when this group is being addressed. The periods for which the circuits are powered up is, therefore, extended slightly so that both are active while the rows K to K+X are being addressed. The active periods of the two circuits 35A and 35B will thus overlap to a small extent, as shown in the control timing diagram in FIG. 3 where Tb indicates the overlap period. However, as the number of pixels rows constituting the group is comparatively low, then the fraction of the total field period for which both circuits are operating simultaneously will be very small. The driver circuits thus still operate substantially alternately, in consecutive time periods and the increase in power consumption in this embodiment compared to the previous embodiment will be minimal.

The overall amount of the power saved in the column drive circuitry when using the above-described approaches is significant especially in reflective display devices in which the column driver circuit tends to be a major consumer of electrical power.

From reading the present disclosure, other modifications will be apparent to persons skilled in the art. Such modifications may involve other features which are already known in the field of AMLCDs and component parts therefor and which may be used instead of or in addition to features already described herein.

1. An active matrix liquid crystal display device comprising a row and column array of pixels defining a display area, each pixel comprising a liquid crystal display element connected to a switching device, sets of row and column address conductors connected to the pixels and via which selection signals and data signals respectively are applied to the pixels, a row driver for applying selection signals to the row address conductors so as to select each row of pixels of the array in turn, and a column driver for applying data signals to a selected row of pixels via the column address conductors, wherein the column address conductors are each divided into first and second portions to define respectively first and second display regions of the display area and the portions of the column address conductors in each of the two display regions are connected respectively to first and second column drivers which are arranged to operate at least substantially alternately to supply data signals for pixels in the first and second display regions respectively as the relevant rows are selected by the row driver.

2. A device according to claim 1, characterised in that the column address conductors are divided around the middle of the pixel array.

3. A device according to claim 2, characterised in that the divisions of the column address conductors lie within a range of adjacent pixel rows centred around the middle of the pixel array.

4. A device according to claim 3, characterised in that the points of division from column to column are substantially irregular.

5. A device according to any one of the preceding claims, characterised in that the first and second column drivers are integrated on a substrate of the device carrying the sets of address conductors and the pixel switching devices.

6. A device according to claim 1, characterised in that a control circuit is connected to the first and second column drivers which controls the operation the column drivers within a field period in which all the pixel rows are addressed such that each applies data signals for its respective display region in respective sub-periods which together occupy a field period and is inactive for the remainder of the field period.
